(19) United States
(12) Patent Application Publication
(10) Pub. No.: US 2006/0001919 A1
(43) Pub. Date: Jan. 5, 2006

(54) Auto-document feed scanning apparatus and method

(76) Inventors: Brian K. Owens, Lexington, KY (US); Donald N. Spitz, Lexington, KY (US); Gregory P. Washnock, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/883,428

(22) Filed: Jun. 30, 2004

(51) Int. Cl. H04N 1/04

(52) U.S. Cl. 358/498

(57) ABSTRACT

The present invention provides, an improved auto-document feed scanning apparatus and method. The apparatus comprises one of a multi-function peripheral having a scanner or a stand alone scanner, having an input tray adjacent to or integral with an auto-document feeder housing. The auto-document feeder housing has at least one feed roll for indexing a target media. An auto-document feed downguide is positioned within the housing and has at least one recognizable surface opposing a scan module. The recognizable surface defines a background for the scan module.

### CROSS REFERENCES TO RELATED APPLICATIONS

This patent application is related to the U.S. patent application Ser. No. 10/764,154 filed Jan. 24, 2004, entitled “Scanning Apparatus and Method for Full Page Scans” and assigned to the assignee of the present application.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to an improved auto document feeding apparatus and method. More particularly, the present invention relates to an image reading and recording apparatus including an auto-document feed scanning apparatus having at least one surface which provides for recognition by a scanning module for improved full-page scanning.

2. Description of the Related Art

Image reading devices or scanners are used to scan a target image or target media to create scanned image data which may be displayed on a computer monitor, used by a computer program, printed, faxed, or saved to memory, a magnetic drive, an optical drive or other fixed or removable memory device. Such image reading devices may be packaged as a stand alone device or as part of a multi-function peripheral device, including a printing or image recording component to perform scanning as well as copy and fax functions.

Some image reading devices include an automatic document feeder for automatically loading and unloading single sheets in a sequential manner such that the image reading function may occur for copying, faxing, displaying, printing, or the like. Following such operation, the automatic document feeder mechanism may output the target media and input a subsequent target document to the scanning station in a sequential manner. Thus, a flow of target media by the automatic document feeder is established without the necessity of manually handling each target media thereby reducing the time and expense of accomplishing the scanning of a stack or plurality of target documents.

Scanning or image reading devices operate by imaging a target object from a sheet of paper or other media with a light source and sensing a resultant light signal with a sensor array typically housed within a scan module or assembly. Each optical sensor generates a data signal representing the light intensity for a corresponding portion of the target object. The image data signals from the array sensors may then be processed or saved for subsequent manipulation, printing or display. The image of the target object is projected to the optical sensor array incrementally by use of a moving scan module or by moving a media with respect to the scan module wherein the optical sensors may be housed.

Generally two types of optical sensors may be used in image reading devices. One type of sensor commonly used with image reading devices is a charge coupled device (CCD). The CCD array may be mounted on a circuit board and may be formed of a collection of tiny light-sensitive diodes which convert photons into electrons. These diodes, also called photosites, operate such that the brighter the light that hits a single photosite, the greater the electrical charge that will accumulate at that site. The target image may be scanned using a light source, such as a fluorescent bulb, and may reach the CCD array through a series of mirrors, filters and lenses. Generally, a CCD builds an electrical charge in response to exposure to light. The amount of charge buildup is dependent on the intensity and duration of the exposure to the light. Such CCD cells are typically aligned in a linear array so that each cell has a portion of a target image impinged thereon as the array moves relative to the target document or the document moves relative to the array.

Differentiating from charge coupled devices, a contact image sensor (CIS) may alternatively be utilized to perform the scanning function of a target document. The CIS may include an array of light sources, such as light emitting diodes (LEDs) and array of photosensors adjacent the LEDs for converting the light to electrical signals for processing of the image generated. The LEDs are generally placed very close to a transparent plate upon which a target media may be positioned. The LEDs may include red, green, and blue light emitting diodes which combine to produce a white light source which is captured by the row of sensors. Color scanning may be performed by illuminating each color type of LED separately and then combining the three scans. An advantage of the CIS is that it is less susceptible to having foreign particles such as dust settle on the optics system which can degrade the scanned image quality. Further, the CIS has fewer reflecting optics than the CCD scanner device and therefore has a smaller size due to its optical configuration.

As previously indicated, various flat bed scanners include an automatic document feeder which automatically feeds media sequentially for scanning. Each target media is conveyed to a scanning position over a flat plate or platen where the target media is scanned by an image sensor followed by advancing of the target media to a media output tray. Typically, the image sensor is fixed at a point beneath the platen for reading as the media is indexed over the image sensor.

One problem occurs when a target media is advanced through an automatic document feeder for a full page scan. In order to exclude an edge or other such artifact from the scanned image data, a scanning device may arbitrarily delete some portion of the scanned data around the edge of the scanned image data. Otherwise stated, edges and line artifacts are deleted from the image data produced during the scan operation. For instance, some scanning devices may scan an image and arbitrarily delete up to about three millimeters per edge to insure that an artifact or housing edge is not included in the scanned image data.

Arbitrary deletion of a portion of the scanned image does not cause problems under some circumstances. When a text document is scanned, for example, deletion of portions of the edges may not generally degrade the quality of the scanned text since such documents typically have a blank border defining a margin. In other words, no useful data is likely to be deleted. To the contrary, full-page scans of images are becoming increasingly popular among peripheral users. If a borderless full-page image is scanned, arbitrary deletion of some portion of the data near the image edge may be undesirable. For instance, some images may include data on a border such as an image, a telephone number, e-mail address, artist name or other important data disposed along an edge or border which may be arbitrarily deleted to insure that an edge is not included in the scanned image data. Thus, one can clearly understand the deletion of useful scanned data is highly undesirable.

Given the foregoing deficiencies, it will be appreciated that a scanning device is needed which determines media edges so that the edge may be removed from the scanned data and so that image data is not arbitrarily deleted.

### SUMMARY OF THE INVENTION

With regard to the foregoing, the present invention eliminates the oversights, difficulties, and disadvantages of the prior art by providing an improved auto-document feeder scanning apparatus and method for making full-page scans utilizing an auto-document feeder using a method of detection of an edge of the target document or media by a scanning module which recognizes a background on an opposed surface of an auto-document feeder downguide.

According to the invention, an improved scanning apparatus and method for full-page scanning is provided. The apparatus comprises an auto-document feed scanning portion having an auto-document feed downguide including a lower surface with a recognizable background thereon. More specifically the background is recognized by the scan module and image sensor therein so that the scan module can distinguish a document edge for improved full-page scanning.

The present method comprises feeding a target media through an auto-document feeder, calibrating a scanner to a calibration strip, calibrating a background of an auto-document feeder downguide surface, scanning at least two lines of the target media to produce scan data, determining a target media width based on said scan data, and taking data from arrays receiving valid target image data.

Alternatively, the method may comprise the steps of feeding a target document through an auto-document feeder, calibrating a scanner to a calibration strip, calibrating a background on an auto-document feeder downguide surface, scanning the background and the target media to produce scan data, and, digitally deleting the background from the scan data.

### BRIEF DESCRIPTION OF THE DRAWINGS

FIG. 1 is a perspective view of a multi-function peripheral of the present invention having a scanner including an auto-document feeder.

FIG. 2 is perspective view of the auto-document feeder including input and output trays which may be utilized with the multi-function peripheral of FIG. 1.

FIG. 3 is a perspective view of the auto-document feeder of FIG. 2 with the trays removed.

FIG. 4 is a side sectional view of the auto-document feeder of FIG. 2.

FIG. 5 is a lower perspective view of an auto-document feeder and downguide.

FIG. 6 is a side perspective view of the auto-document feeder with cut-away. portion and scan module located below the downguide.

FIG. 7 is a downguide lower surface having a solid pattern for recognition by the scan module and a target media passing the lower surface.

FIG. 8 is a downguide lower surface having a solid color for recognition by the scan module.

FIG. 9 is a downguide lower surface having a recognizable gradient.

FIG. 10 is a downguide lower surface having recognizable color ends.

FIG. 11 is a downguide lower surface having recognizable patterned ends.

FIG. 12 is a downguide lower surface having a plurality of alternative recognizable patterns.

### DETAILED DESCRIPTION

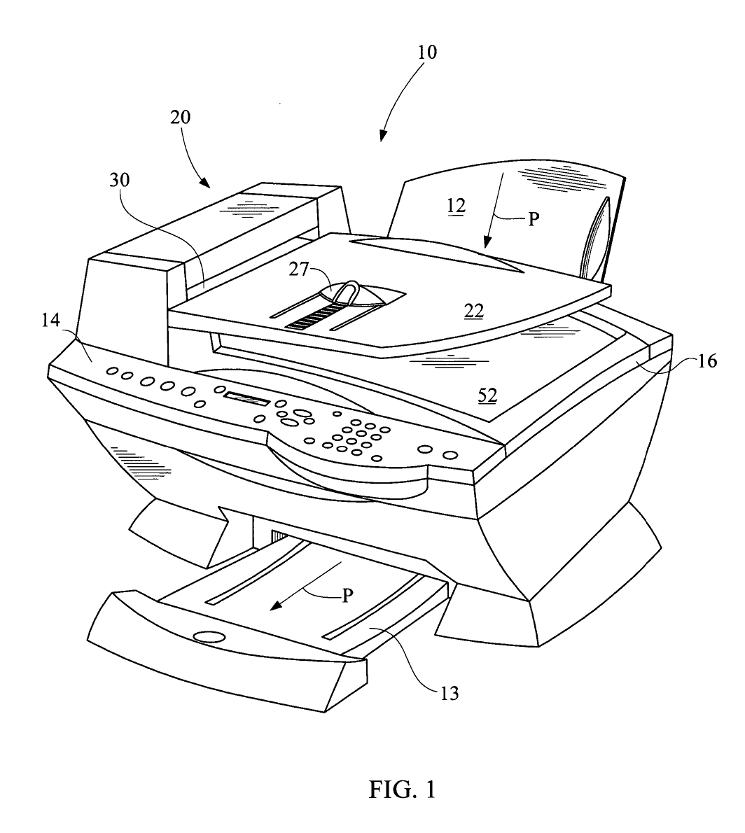

Referring now in detail to the drawings, wherein like numerals indicate like elements throughout the several views, there are shown in FIGS. 1 through 12 various aspects of an improved auto-document feed scanning apparatus and method. The device comprises a multi-function peripheral having a scanner portion and an auto-document feeder for automatically scanning a plurality of target media. The auto-document feeder utilizes a recognizable indicia located on a document downguide portion within the auto-document feeder. Such recognizable pattern is disposed opposite a scanning station for a scanning module so that sensors therein may detect the recognizable indicia and detect a page edge.

For purposes of this invention description the term scanning direction is defined as the direction of movement of the target document through the auto-document feeder. Further, use of the term image hereinafter is meant to include photographs, drawings, text images or any other scannable target objects. A full page scan is defined as a scan of an image wherein scanned edge data from the image is not removed or deleted in order to ensure elimination of edge lines or other artifacts introduced during a full-page scan function.

Referring initially to FIG. 1, a multi-function peripheral 10 is depicted including a printing component and a scanning component. The multi-function peripheral 10 may be utilized for printing, copying, scanning, and faxing documents while connected to a computer or network print server. The printing component is represented illustratively by an input tray 12 and an output tray 13 which define a feed path indicated by arrows P. Within the housing of the multi-function peripheral 10, a laser printer, thermal inkjet printer or piezo inkjet printer is used for forming an image on the print media as it moves from input tray 12 to output tray 13 of the printing component. The multi-function peripheral further comprises a control panel 14 including a plurality of control buttons for inputting commands and making selections. The device may also comprise an LCD screen for providing instruction or selections to a user.

The multi-function peripheral 10 comprises a scanning component including a flatbed scanner 16 and an auto-document feed scanning apparatus 20. The flatbed scanner 16 is positioned adjacent the control panel 14 and above the exit tray 13. Further, the flatbed scanner 16 may be utilized to manually scan target documents. The auto-document feed scanning apparatus 20 is positioned at an end of the peripheral 10 and above the flatbed scanner 16. The auto-document feed scanner apparatus 20 will automatically index and scan a plurality of media so that the images maybe printed, copied, faxed, or saved to memory, a host PC, a network or other media.

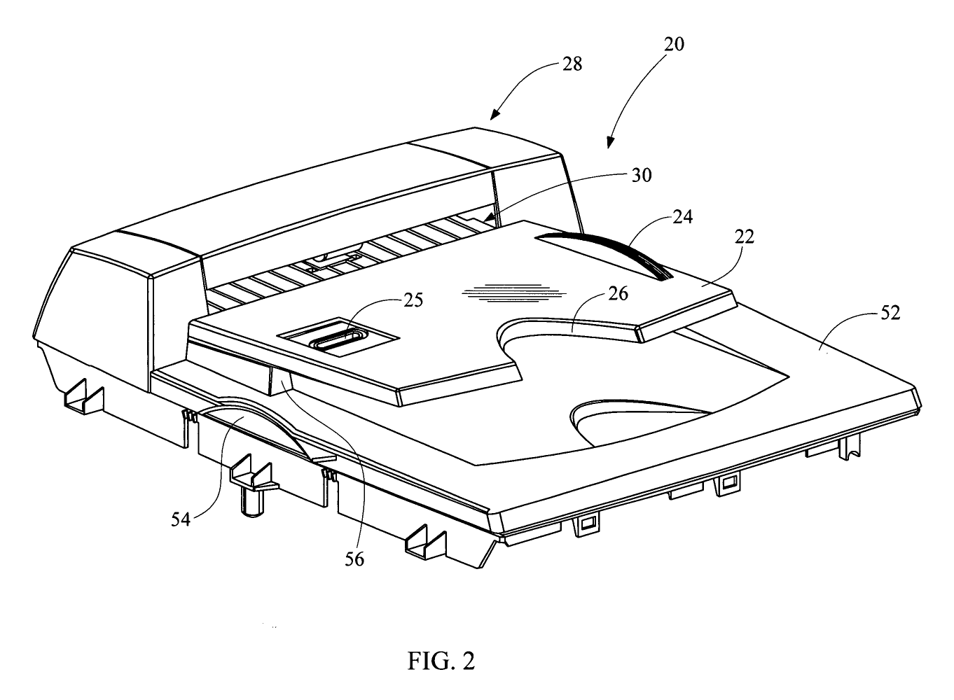

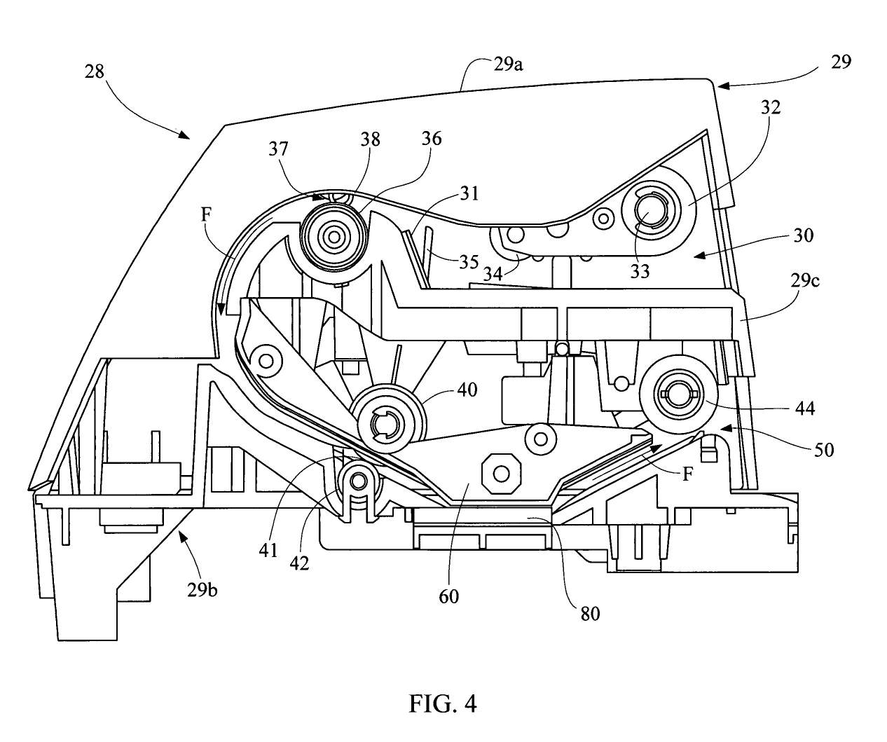

Referring now to FIG. 2, the auto-document feed scanning apparatus 20 is shown having an input tray 22 adjacent an input aperture 30 of an auto-document feeder housing 29 (FIG. 4). Alternatively, the input tray 22 may be formed integral with the feeder housing 29. The input tray 22 is generally rectangular in shape but may be various shapes defining an upper surface for supporting a plurality of target media thereon. An alignment wall 24 is depicted extending vertically from the input tray 22 for aligning an edge of the target media as they are fed into the auto-document feeder 28. The alignment wall 24 includes a vertical wall extending from the input tray 22 having a curvilinear upper edge. However, the alignment wall 24 can be formed of various shapes which will engage a plurality of sheets along a common edge for proper alignment during feeding. Opposite the fixed alignment wall 24 may be a slot 25 for receiving a moveable alignment device 27 (FIG. 1) opposite the fixed alignment wall 24. The moveable alignment device 27 provides adjustment for feeding of target documents of varying width. Also disposed within the input tray 22 is a recess 26 allowing a user to position the target media on the input tray 22 and push the target media against at least one blocking member 35 (FIG. 4) within the auto-document feeder 28.

Still referring to FIG. 2, disposed beneath the input tray 22 is an output tray 52 which is generally depicted having a surface area larger than the input tray 22. The output tray 52 receives target media after scanning through the auto-document feeder 28 for retrieval by the user. The output tray 52 is generally rectangular including four sides defining an upper surface where media is supported upon exiting the auto-document feeder 28. One of the sides includes a handle 54 for raising the output tray. On a side opposite the handle 54 can be at least one pivotal connection (not shown) between the output tray 52 and the peripheral housing providing access to a flat bed scanner platen for manually scanning target documents. Also extending from the upper surface of the output tray 52 is at least one spacer 56 providing a spaced connection between the input tray 22 and the output tray 52 and providing spacing for a stack of target documents exiting the auto-document feeder 28 onto the output tray 52. In other words, the at least one spacer 56 provides a vertical clearance so that a stack of documents exiting to the output tray 52 does not interfere with the input tray 22. Thus, the at least one spacer 56 may be sized to accommodate a preselected amount of media and the preselected amount may be increased or decreased by increasing or decreasing the size of the spacer 56.

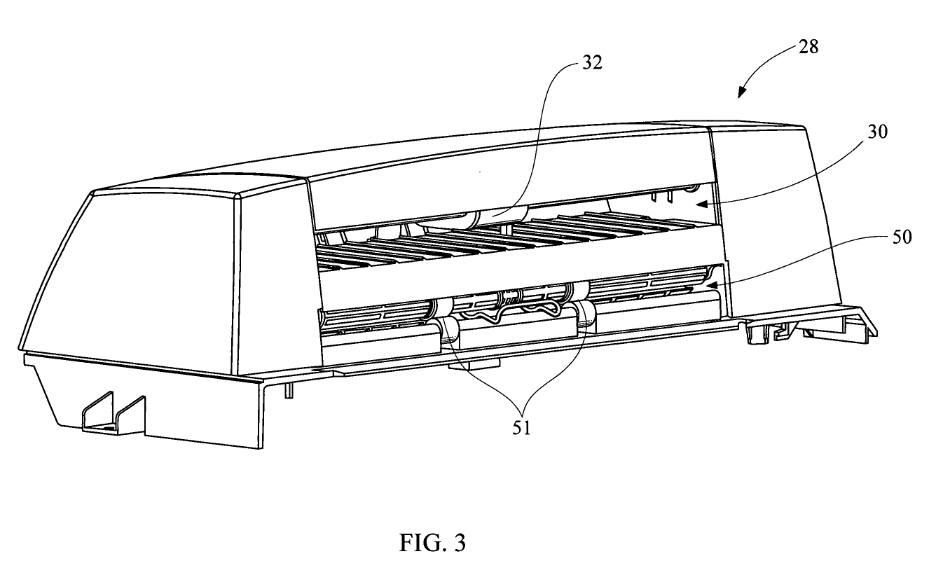

Referring now to FIG. 3, the auto-document feeder 28 is shown with the input tray 22 and output tray 52 removed. The auto-document feeder 28 has a front surface including an input aperture 30 disposed above an exit aperture 50. The input aperture 30 is substantially rectangular in shape and within the opening or aperture 30 is an auto-compensating mechanism 32 having at least one pick tire or roller 34 (FIG. 4) for advancing a target document into the auto-document feeder 28. As previously indicated, a scanning direction is defined between the input aperture 30 and the exit aperture 50 so that target media is fed from the input tray 22 (FIG. 2) through the input aperture 30, through the feed path (F) and out of the exit aperture 50 onto the output tray 52 (see FIG. 4). Proximate the exit aperture 50 are output nips 51 defined by at least one roller which receives the target media from the feed path within the auto-document feeder 28 and advances the target media from within the auto-document feeder 28 to the output tray 52 (FIG. 2).

Referring now to FIG. 4, a side sectional view of the auto-document feeder 28 of FIG. 3 is shown. The auto-document feeder is defined by a housing 29 including a top cover 29a, a lower housing 29b, an auto-document feeder frame 29c, and an auto-document feeder downguide 60. Although the illustrative housing 29 is defined by various parts, it is well within the scope of the present invention that the housing 29 be defined from one part or more parts than described herein. The top cover 29a and the lower housing 29b define an outer portion of a feed path F while the auto-document feed frame 29c and the auto-document feeder downguide 60 define an inner portion of the feed path F. The top cover 29a and the auto-document feed frame 29c define the upper portion of a feed path F while the lower housing 29b and the auto-document feeder downguide 60 define a lower portion of the feed path F within the auto-document feed housing 29. On the right hand side of the housing 29 are the input aperture 30 and the output aperture 50 disposed beneath the input aperture 30. When target media is positioned through the input aperture 30, the media engages a media blocking mechanism 35 which is pivotally mounted within the housing 29 and is depicted in a vertical position. The media blocking mechanism 35 provides positive engagement for the target media so that the user perceives a definitive stop and does not over force the target media into the housing 29. The media blocking mechanism 35 pivots between a substantially vertical position and a position about 20 degrees from the vertical aligned with media dams 31.

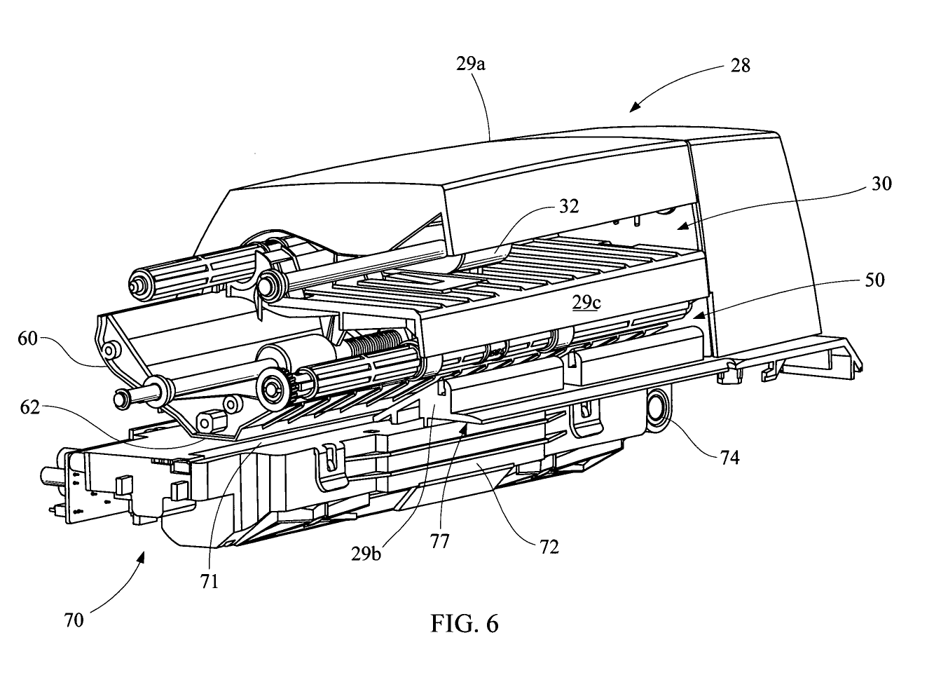

Still referring to FIG. 4, within the input aperture 30 is the auto-compensating mechanism 32 which is driven by drive shaft 33 in order to turn a plurality of gears within the auto-compensating mechanism 32 and drive a pick tire 34. The auto-compensating mechanism 32 is depicted in an idle position, but upon preselected rotation of the drive shaft 33, the auto-compensating mechanism 32 lowers to engage a media stack. In the engaged position, the pick tire 34 rotates and advances the target media to a delivery nip 37 formed between a delivery roll 36 and delivery idler 38. Between the auto-compensating mechanism 32 and a media blocking mechanism 35, a plurality of sheets disposed on the input tray 22 (FIG. 2) are positioned to begin feeding through the auto-document feeder 28. When the auto-compensating mechanism 32 lowers, the media blocking mechanism 35 pivots into alignment with the media dams 31 so target media may advance through the auto-document feeder 28. According to the present embodiment a feed path F is defined within the housing 29 and is represented by the arrows indicated as F throughout the housing 29. Downstream, in the scanning direction, of the media blocking mechanism 35 and media dam 31 is the at least one delivery roller 36 and idler 38 defining a delivery nip 37. As previously indicated, the ACM 32 and pick tire 34 advance a media or target document over the media dam 31 and into the delivery nip 37 for further advancing through the feed path F. At least one delivery roller 36 advances the target media through the feed path F within the housing 29 and advances the media at a faster rate than the auto-compensating mechanism 32. The target media follows the feed path F to a lower feed nip 41 defined by feed roller 40 and feed idler 42. When the target media advances to the feed nip 41, the feed roller 40 initially rotates in a direction opposite the feed direction F. This de-skews the media as it engages the rollers 40, 42. After de-skewing, the roller 40 direction is reversed to feed the target media. The feed nip 41 directs the target media between the auto-document feeder downguide 60 and a glass plate or platen 80 suspended beneath the downguide 60 and above a scanning module 70 (FIG. 6). On the opposite side of the auto-document feeder downguide 60 is an output roller 44 which receives the target media being fed from media nip 41 and continues advancing the target media from within the auto-document feeder 28 to the output tray 52. As previously indicated and shown in FIG. 3, an output nip 51 is defined by the output roller 44 (FIG. 4) and an output idler (FIG. 3) adjacent the output aperture 50 in order to advance the target media from within the auto-document feeder 28 to the exit tray 52.

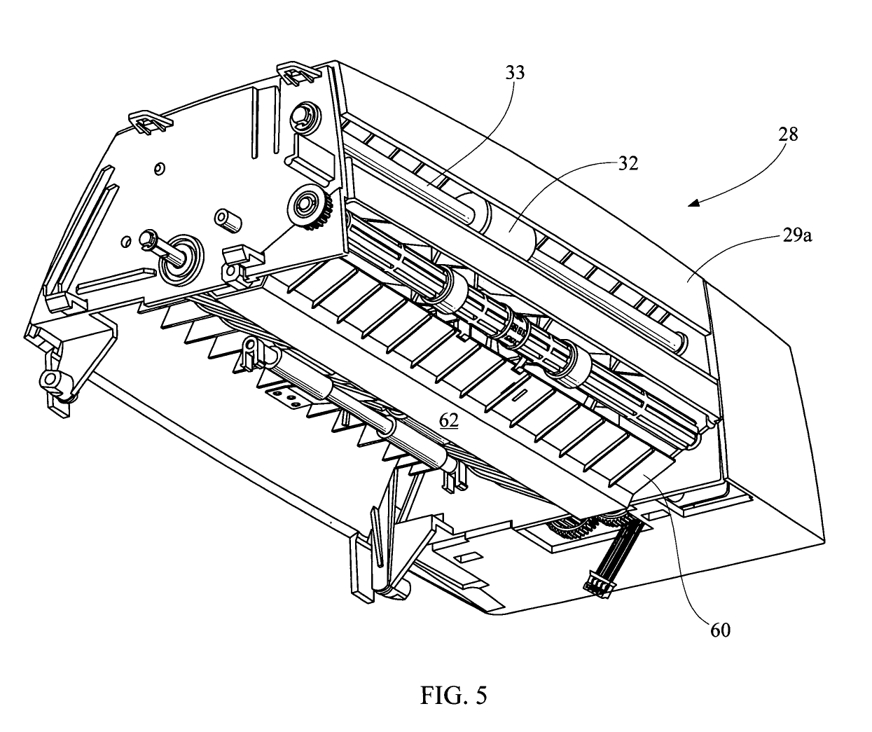

Referring now to FIGS. 5 and 6, the auto-document feeder down guide 60 is shown mounted within the auto-document feeder 28. The auto-document feeder downguide 60 is mounted between the upper housing 29a and the lower housing 29b. More specifically, the downguide 60 is disposed between the auto-document feeder frame 29c and the lower housing 29b (FIG. 4) and thus defines the lower portion of the inner feed path F (FIG. 4). The auto-document feeder downguide 60 is substantially triangular in cross section with a lower flat surface 62. The lower flat surface 62 is positioned opposite a scanning module or assembly 70 so that a gap is provided between an upper surface of the scanning module 70 and the lower surface 62 of the auto-document feeder downguide 60. As seen in FIG. 4, the gap defines a portion of the feed path F so that the target media is guided between the downguide 60 and the scanning module 70. The upper surface of the scanning module includes a window 71 through which a light source directs light either directly or indirectly on a target document passing above. Further as shown in FIG. 4, a glass platen 80 is suspended from the lower housing 29b and is disposed between the downguide 60 and scanning module 70 of FIG. 6. The platen 80 supports the target media through the feed path F while maintaining visual communication between the scanning module 70 and the lower surface 62 or target media passing there between.

The scanning module 70 is slidably positioned on at least one scan module guide rod (not shown) for slidable movement between the auto-document feed scanning position shown in FIG. 6 and a flat-bed scanning position. The scanning module housing 72 includes a guide rod or shaft aperture 74 for slidable movement. Such movement may be effected by a plurality of alternative means including, for instance, at least one motor and pulley system (not shown). However, alternative drive designs as is known to those of skill in the art can be also be utilized and are felt to be within the scope of the present invention.

Within the scanning module housing 72 can be, for instance, either a charge coupled device (CCD) or a contact image sensor (CIS) type. As previously discussed, the CCD scanner utilizes a CCD array which can be mounted on circuit board. The image of the document is scanned using a light source within the housing 72, such as a fluorescent bulb which reaches the CCD array through a series of mirrors, filters and lenses. The exact configuration of these components may depend on the model of scanner. Some CCD scan bars use a three pass scanning method. Each pass utilizes a different color filter (red, green or blue) between the lens and CCD array. After the three passes are completed, the scanner software assembles the three filtered images into a single full-color image. However, most CCD scanners use the single pass method. The lens splits the image into three smaller versions of the original. Each smaller version passes through a color filter (either red, green or blue) onto a discrete section of the CCD array. The scanner software combines the data from the three parts of the CCD array into a single full-color image.

Alternatively, a less expensive scanner utilizing contact image sensors (CIS) may be positioned within the scanner module 70. According to this embodiment, a CIS array replaces the CCD array, mirrors, filters, lamp and lens with an array of red, green and blue light emitting diodes (LEDs) and a corresponding array of phototransistors. The image sensor array consisting of 600, 1200, 2400 or 4800 LEDs and phototransistors per inch (depending on resolution) spans the width of the scan area and is placed very close to the platen 80 upon which rests the image to be scanned. When the image is scanned, the LEDs combine to provide a white light source. The illuminated image may be then captured by the row of sensors. Color scanning is performed by illuminating each color type of LED separately and then combining the three scans. Hereinafter, use of the term scanning module 70 should be understood to include an image sensor array and other elements previously described for performing a scanning function.

Referring again to FIG. 6, a calibration strip 77 may be positioned on a lower surface of the lower housing 29b and opposite the upper surface of the scanning module 70. The calibration strip 77 may be a white strip of material which the scanning module 70 utilizes to calibrate before scanning. Alternatively, the calibration strip may be black, a combination of white and black, or two or more contrasting colors. The calibration strip 77 may be formed of various shapes including a rectangular shape matching the window 71 disposed in the upper surface of the scanning module 70. The calibrations strip 77 may further comprise an origin mark (not shown) to orient the scanbar 60 to its home position. Alternatively, the origin mark (not shown) may be positioned in a different location so that the origin mark may be recognized when the scanning module 70 is positioned for auto-document feed scanning.

Referring still to FIGS. 5 and 6, the lower flat surface 62 includes an indicia thereon for the scanning module 70 to recognize. The lower surface 62 is substantially rectangular in shape and extends the length of the downguide 60. The downguide surface 62 may vary in length but should be sized to be wider than most commonly utilized media sizes so that an entire width of the media may be distinguished from the background. As previously indicated, the glass plate or platen 80 (FIG. 4) is positioned beneath the downguide lower surface 62 between the lower surface 62 and scanning module 70 so that the target media passes between the platen 80 and the lower surface 62 and is supported by the platen 80.

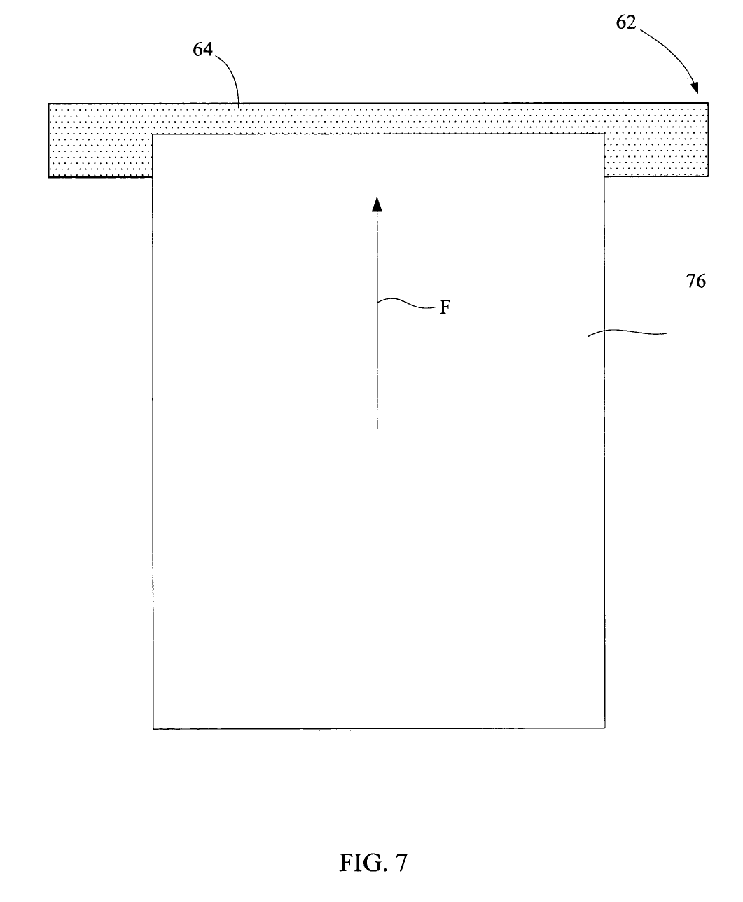

Referring now to FIG. 7, a bottom view of the feed path F at the scanning module 70 is shown. As depicted, the lower surface 62 includes a recognizable indicia defining a background 64, for example, a patterned plurality of dots. The scanning module 70 operates to recognize the indicia or background 64 of the lower surface 62 so that the sensors of the scanning module 70 distinguish the target object or image from the lower surface 62 of the downguide 60. Further depicted in the FIG. 7 is a target media 76 passing beneath the downguide lower surface 62. As one of ordinary skill in the art will understand from this description, since the background 64 is recognizable, as the target media 76 passes adjacent to the downguide 60 between the lower surface 62 and the scanning module 70, the scanning module 70 will distinguish the known background 64 from the target media 76. By detecting the known or recognizable indicia 64 on the lower surface 62 of the scanning module 70 the edges of the target media 76 can be determined and an improved full-page scan may be performed in two ways. According to a first method, the media width of the target media 76 is determined based on the first few scan lines. After such determination, the scan continues for only the v valid pixels representing the image within the width of the target document 76. According to a second method, the media width is determined by scanning the entire document and digitally deleting the recognizable background 64. Otherwise stated, this alternative embodiment -of the present invention effectively inserts at least one known background into a scanned image and, subsequently removes the recognized or known background from the scanned data before exporting the scanned data to, for instance, a host PC, a printer, or onboard or external memory or storage.

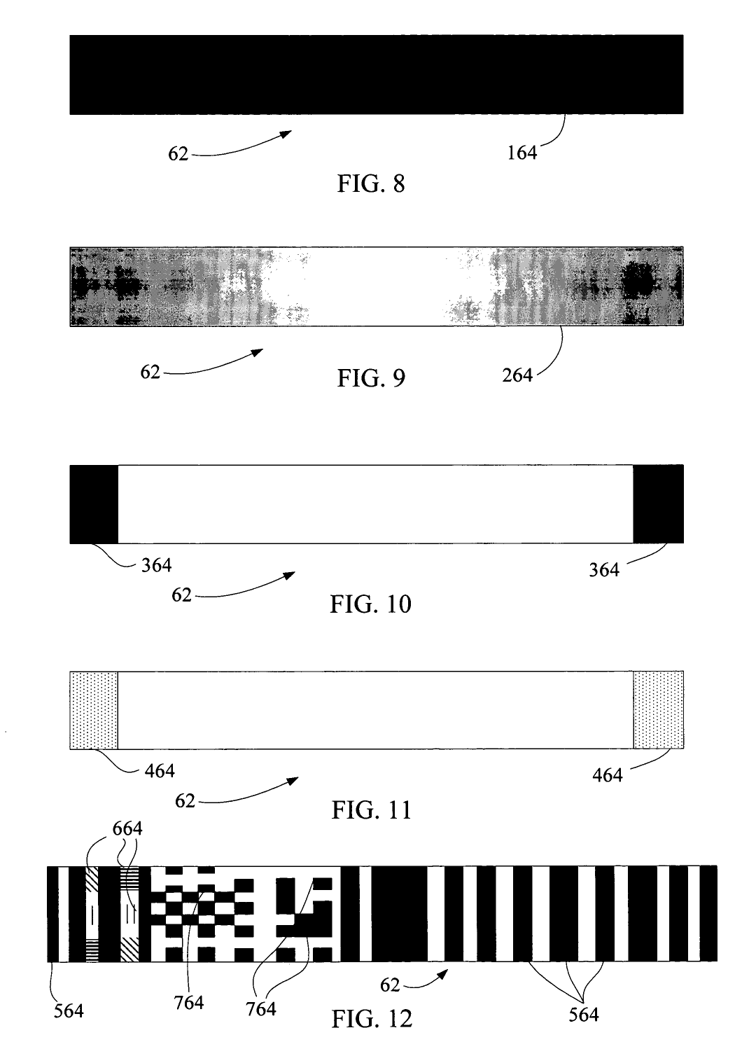

Referring now to FIGS. 7-12, a plurality of backgrounds are shown for use with the auto-document feed downguide 62. The background indicia may be molded, painted, screen printed, or some combination thereof on the lower surface 62. The paint or screen-print may be defined by some contrasting color to the plastic defining the lower surface 62 of downguide 60 so that the recognizable background 64 can be distinguished by the scanning module 70. Referring first to FIG. 7, a pattern 64 of recognizable indicia is depicted as a pattern of shapes, for instance dots. The dots may be defined by squares, bars, other relatively small shapes, or combinations thereof. As shown in FIG. 8, an alternative background 164 may comprise a solid color. As shown in FIG. 9, another alternative background 264 may comprise a color gradient. As shown in FIG. 10, an alternative background 364 may include at least one color disposed at edges of a preselected media size. According to this embodiment, edges of the target media may pass over the indicia 364 so that the scanner recognizes the media size. Alternatively, a pattern 464 rather than a solid color may be positioned corresponding to preselected sizes of media, as shown in FIG. 11. Alternatively, the gradient or other patterns may be positioned at the edges of the lower surface 62 or at positions intermediate the ends for preselected sizes, for instance, letter size. As shown in FIG. 12, a plurality of patterns are depicted which may be utilized alone or in combination. The patterns may include bars 564 which may vary in width or may all be the same width. The patterns may also include lines 664 which are horizontal, vertical, or diagonal and may be continuous or interrupted and may vary in width or all be the same width. The patterns may include dots or small squares 764 which may be spaced apart or grouped to define shapes or patterns such as checkered patterns. The dots may also vary in size. In any of the embodiments, the background is recognized by the scanning module 70 so as to distinguish the background of the downguide lower surface 62, from a target media or target image passing between the scanning module 70 and the recognizable lower surface 62.

According to yet a further alternative embodiment, the lower surface 62 may include ridges defining the preselected shapes of the backgrounds previously discussed. For instance the raised ridges may define bars, dots, squares or combinations thereof. The scanning module opening or window 71 may read the ridges when the scan module 70 is disposed beneath the lower surface 62. In a first alternative embodiment, the ridges may be painted or printed, for instance screen-printed, with some color which contrasts the color of the molded lower surface 62. With a contrasting color, the scanning module sensor 70 will be able to easily distinguish the at least one pattern from the adjacent plastic defining the lower surface 62 of the downguide 60. For example, if the molded plastic has a color of black, then the ridges may be painted or printed white or vice-versa. With the ridges formed, a paint or-ink source may be rolled across the raised edge and only contacting the upper surface of the ridges because of their height difference thus aiding in providing the aforementioned contrast.

In operation, the auto-document feed scanning apparatus 20 may operate in either of two methods generally described previously. According to either method, the scan module 70 is calibrated against a known color of the calibration strip 77 by utilizing a valid light source such as a fluorescent tube or high-intensity discharge lamp. After calibration, the scan module 70 may calibrate an origin mark to ensure proper positioning of the scan module 77.

Next, the scanning module may be calibrated against a background 64 of the downguide surface 62. This calibration ensures that the background 64 is recognized by the scanning module 70. The scanning module 70 shines a valid light source on the background 64 so that images of the surface 62 may be captured and stored in on-board memory (not shown) for recognition.

After calibration of the scanning module 70 and the background surface 62, movement of the target media is initiated. The auto-document feeder 20 begins operation by signaling a pick motor to rotate drive shaft 33 and causing the auto-compensating mechanism 32 to rotate from an idle position toward a target media stack. As the auto-compensating mechanism 32 moves downward, the media blocking mechanism 35 rotates between the media dams 31 allowing the media to pass by. As the drive shaft 33 rotates, the pick tire 34 is also induced to rotate advancing a sheet of the target media to the delivery nip 37 which further advances the target sheet to the feed nip 41.

As previously indicated, the feed roller 40 first performs a de-skewing operation by reversing the feed roller 40 causing the target media to straighten before the feed roller 40. Once the de-skewing procedure is complete, the feed roller 40 changes direction to advance the target media in a scanning direction. The media is advanced beneath the downguide 60 and over the platen 80 so that the target media enters the scanning area above the scanning module 70.

As the target media is advanced in the scanning direction, a leading edge of the target media begins to pass between background 64 and the scanning module 70. Initially the scanning module 70 is acquiring data representative of the downguide surface 62, for instance, background 64. As depicted in FIG. 7, when the target media begins passing the background 64, the scanning module 70 is acquiring data with each movement of the target media across the downguide surface 62. According to a first embodiment of the present method, the scanning module 70 detects the target media passing the background surface 62 and determines the leading edge of the target document as the background 64 disappears. The width of the target media is determined within at least two swaths of scanning the media since at least two points are necessary to define a line or edge. Alternatively, an edge might be approximated based on a single swath of scanned image data. However, this edge definition would be more likely to have errors because a single swath of scanned data would not account for skew in the target media. For instance, when acquiring a target data, if the target media were skewed such that the scan module 70 detected a first side edge, for instance, and one leading edge, the scan module 70 would incorrectly interpret a single swath of scan data to include a second side edge of the target media. To the contrary, with at least two scans, the scan module 70 would not determine the second side edge until two readings were taken from substantially the same location of the scan array. Thus the correct second side edge is determined and the side edge is properly approximated across the length of the target media. Consequently, it is preferable that at least two swaths of data be utilized to determine the target media edge.

In order to determine the width of the target document, one of ordinary skill in the art will realize that as the target media passes adjacent the downguide surface 62 and, for instance, background 64, end portions along each side of the media will be recognizable by the scanning module 70. By recognizing the edges within the first few swaths of data acquisition of the scanning module 70, the edges of the target document are approximated across the length of the target media. The trailing edge of the target media is determined as the scanning module 70 begins recognizing the background of the downguide surface 62. This occurs as the trailing edge of the target media passes the downguide surface 62. Thus, only valid portions of the scan module array acquire data after the edges are approximated during this first full-page scan process. Otherwise stated, once the media width is determined within a few swaths of data acquisition, only the scan arrays of the scan module 70 which acquire valid data from the target media are operating as the target media passes.

According to a second embodiment, the recognizable background, for instance background 64, is inserted into the scanned image and digitally deleted so that a full-page scan is all that is left in the image data. In the second embodiment, the full scanner array of the scanning module 70 takes data as the target media passes between the scanning module 70 and the lower surface 62. Since the entire image sensor array of the module 70 operates, the full target media and background 64 are captured. This scan image, including background 64, are stored in memory until scanning of the document is completed. Next, the background, for instance, background 64, may be automatically digitally deleted by a processor within the auto-document feed scanning apparatus 20. Alternatively, the current state of the art method may be utilized by utilized by connecting a personal computer (PC) to the peripheral 10 and deleting the background 64 through software on the PC. Accordingly, the automatic deletion method renders a full page scan without deleting any of the image data. An advantage to this automatic method is that the method is generally more accurate for determining an edge of the target media. However, this method is also more resource intensive since it requires the scan data for each document to be stored before the data is manipulated. Further, the entire target document must be scanned before printing, or copying can occur.

It is apparent that variations may be made to the improved scanning apparatus and methods for full-page scan of the present invention in regards to specific design elements thereof. Such variations however are deemed to fall within the teachings of the present invention as generally modifications may be made to placement of the particular structure described herein while falling within the general teachings hereof.

We claim:

1. An improved automatic document feed scanning apparatus, comprising:
a multi-function peripheral having at least a scanner including a scanbar;
an input tray adjacent an auto-document feeder housing;
said auto-document feeder housing having at least one feed roll;
an auto-document feed downguide positioned within said housing, said downguide having at least one surface opposing said scanbar and defining a background scannable by said scanbar.

2. The apparatus of claim 1 wherein said background is recognizable by said scanner.

3. The apparatus of claim 1 wherein said background comprises a solid color.

4. The apparatus of claim 1 wherein said background is defined by a pattern.

5. The apparatus of claim 1 wherein said background comprises a gradient color.

6. The apparatus of claim 1 wherein said background comprises at least a first color and a contrasting second color.

7. The apparatus of claim 6 wherein one of said first color and second color being positioned along outer edges of said background adjacent the outer edges of said scanbar.

8. The apparatus of claim 1 wherein said background comprises at least one pattern portion.

9. The apparatus of claim 8, wherein said at least one pattern portion is positioned along outer edges of said at least one surface.

10. The apparatus of claim 1 wherein said background comprises indicia.

11. The apparatus of claim 10 further comprising said indicia being selected from a group consisting of lines, bars, dots, rectangles, and combinations of two or more of the foregoing.

12. The apparatus of claim 11 further comprising said bars being of varying dimensions.

13. The apparatus of claim 11 further comprising said bars being of equal thickness.

14. The apparatus of claim 11 further comprising said bars being of varying length.

15. The apparatus of claim 1 further comprising said background having shapes of at least two colors.

16. The apparatus of claim 10 further comprising said indicia being a plurality of dots.

17. The apparatus of claim 16 further comprising said plurality of dots defining a checkerboard pattern of at least a first color and a second color.

18. The apparatus of claim 16 further comprising said plurality of dots varying in size.

19. The apparatus of claim 16 further comprising said plurality of dots defining a preselected shape.

20. The apparatus of claim 16 further comprising said plurality of dots being multi-colored.

21. The apparatus of claim 16 further comprising said indicia including a bar and a dot.

22. The apparatus of claim 21 further comprising at least one of said bar and said dot being a second color.

23. The apparatus of claim 10 further comprising said indicia being formed on said housing by one of the following group consisting of screen-printing, painting, printing, molding, pre-printed adhesive strips, or combinations of two or more of the foregoing.

24. An improved document scanner apparatus having a scanbar and a downguide for directing a sheet of media between said scanbar and said downguide for scanning by said scanbar; comprising
a scannable background positioned on a surface of said downguide opposite said scanbar, said background extending coextensive with the length of said scan bar and having indicia being recognizable by said scanbar during scanning said sheet of media wherein the edges of said media can be determined by said scanner by locating said indicia.

25. The apparatus of claim 24 further comprising said indicia being selected from a group consisting of lines, bars, dots, rectangles, and combinations of two or more of the foregoing.

26. The apparatus of claim 25 further comprising said bars being of varying dimensions.

27. The apparatus of claim 25 further comprising said bars being of equal thickness.

28. The apparatus of claim 25 further comprising said bars being of varying length.

29. The apparatus of claim 24 further comprising said indicia having shapes of at least two colors.

30. The apparatus of claim 29 further comprising at least one of said shapes being a plurality of dots.

31. The apparatus of claim 30 further comprising said shapes having a plurality of dots defining a checkerboard pattern of at least a first color and a second color.

32. The apparatus of claim 30 further comprising said plurality of dots varying in size.

33. The apparatus of claim 30 further comprising said plurality of dots being multi-colored.

34. The apparatus of claim 29 further comprising said shapes including a bar and a dot.

35. The apparatus of claim 34 further comprising at least one of said bar and said dot being a second color.

36. The apparatus of claim 25 further comprising said indicia being formed on said housing by one of the following group consisting of screen-printing, painting, printing, molding, pre-printed adhesive strips, or combinations of two or more of the foregoing.

37. The apparatus of claim 24 further comprising at least a portion of said background being selected from a group consisting of a solid color, a pattern, a gradient color, at least a first color and a contrasting second color, and combination of two or more of the foregoing.

38. The apparatus of claim 37 wherein one of said first color and second color being positioned along outer edges of said background adjacent the outer edges of said scanbar.

39. A method of producing a full-page scan of an image in a scanner, comprising the steps of:
feeding a target media through an auto-document feeder;
calibrating said scanner to a calibration strip;
calibrating said scanner to a background on an auto-document feeder downguide surface;
scanning at least two lines of said target media and said background to produce scan data;
determining a target media width based on said at least two scan lines; and
taking data from arrays receiving valid target image data.

40. A method of producing a full-page scan of an image in a scanner, comprising the steps of:
feeding a target document through an auto-document feeder;
calibrating said scanner to a calibration strip;
calibrating said scanner to a background on an auto-document feeder downguide surface;
scanning said background and said target media to produce scan data; and,
digitally deleting said background from said scan data.

41. A method of producing a full-page scan of an image in a scanner, comprising the steps of:
feeding a target media through an auto-document feeder;
calibrating said scanner to a calibration strip;
calibrating said scanner to a background on an auto-document feeder downguide surface;
scanning at least one line of said target media to produce scan data;
determining a target media width based on said at least one line of scan data; and,
taking data from arrays receiving valid target image data.
